(19) United States
(12) Patent Application Publication
(10) Pub. No.: US 2025/0356027 A1
(43) Pub. Date: Nov. 20, 2025

(54) ELECTRONIC DEVICE FOR TESTING SECURE DATA, AND OPERATING METHOD THEREFOR

(71) Applicant: Samsung Electronics Co., Ltd., Suwon-si (KR)

(72) Inventors: Jinsu KIM, Suwon-si (KR); Jungkon KIM, Suwon-si (KR); Jongmin CHOI, Suwon-si (KR); Minho KIM, Suwon-si (KR); Juwoan YOO, Suwon-si (KR); Moonsoo CHANG, Suwon-si (KR); Wonsuk JANG, Suwon-si (KR); Inmyung CHOI, Suwon-si (KR)

(21) Appl. No.: 19/288,046

(22) Filed: Aug. 1, 2025

Related U.S. Application Data
(63) Continuation of application No. PCT/KR2023/020241, filed on Dec. 8, 2023.

(30) Foreign Application Priority Data
Feb. 2, 2023 (KR) 10-2023-0014287

(51) Int. Cl. G06F 21/57; G06F 21/45

(52) U.S. Cl. CPC G06F 21/577; G06F 21/45; G06F 2221/033

(57) ABSTRACT

An electronic device may include: at least one processor; and at least one memory including instructions. When executed by the processor, the instructions may cause the electronic device to: select reference data from a secure space configured for authentication data; apply a first helper matrix to first data in the secure space so as to generate first playback authentication data to be mapped to the first data; apply a second helper matrix to second data in the secure space so as to generate second playback authentication data to be mapped to the second data; and test the first helper matrix and the second helper matrix on the basis of a first angle between the first playback authentication data and the reference data and a second angle between the second playback authentication data and the reference data. Other embodiments are possible.

### CROSS-REFERENCE TO RELATED APPLICATIONS

This application is a continuation application of International Application No. PCT/KR2023/020241, filed on Dec. 8, 2023, in the Korean Intellectual Property Receiving Office, and claiming priority to Korean Patent Application No. 10-2023-0014287 filed Feb. 2, 2023, the disclosures of which are all hereby incorporated by reference herein in their entireties.

### TECHNICAL FIELD

Certain example embodiments may relate to an electronic device for testing secure data and/or an operating method thereof.

### BACKGROUND

As the use of a portable electronic device such as a smartphone, a tablet PC, and a smart watch becomes more common, user demands for portability and convenience of use has increased. The electronic device is an output device which outputs visual information, may provide a touch screen display which replaces a mechanical input device (e.g., a button-type input device), and may include various sensors. For example, the electronic device may include a flexible display, for example, a foldable or rollable display. In addition, recently, the electronic device may be implemented to include a sensor module (or biometric sensor) including various sensors such as a fingerprint sensor, a facial recognition sensor, and/or an iris sensor.

Biometrics in the electronic device may be used for user authentication, and the electronic device may perform the user authentication by receiving an input for the biometrics. For example, if the user authentication is required while an application is executed, the electronic device may receive the input for the biometrics and perform an operation (e.g., a user authentication operation) for the user authentication required in the application.

Recently, there is a need for security for user information or device information. In response to this need, interest in an authentication scheme based on the biometrics has increased. The biometrics is an authentication scheme which is based on biometric data (or biometric information) which differs for each user. Examples of the biometric data may include face data, voice data, fingerprint data, palmistry data, iris data, and/or blood vessel data. Such biometric data represents a unique characteristic of a user of the electronic device, and there is no risk of being stolen, copied, changed, or lost by others such as a password. Therefore, the biometrics based on the biometric data is variously used in a security field.

However, since the biometric data is a unique characteristic of the user and is very important information for the user, security of the biometric data has emerged as a very important issue. Therefore, an authentication scheme (e.g., a fuzzy extractor scheme) has been proposed that generates authentication data by applying a fuzzy technology to the biometric data and uses the generated authentication data for the user authentication without using the biometric data itself as authentication data (or authentication information) used for the user authentication.

In the authentication scheme based on such fuzzy technology, there may be a need for testing secure data (e.g., a helper matrix or helper data) used in the authentication scheme to secure stability of authentication data (e.g., a secret key).

### SUMMARY

According to an example embodiment, an electronic device may comprise at least one processor comprising processing circuitry, and memory storing instructions.

According to an example embodiment, the instructions, when executed individually and/or collectively by the at least one processor, may cause the electronic device to select reference data from a secure space set for authentication data.

According to an example embodiment, the instructions, when executed individually and/or collectively by the at least one processor, may cause the electronic device to apply a first helper matrix to first data in the secure space to generate first reproduced authentication data mapped to the first data.

According to an example embodiment, the instructions, when executed individually and/or collectively by the at least one processor, may cause the electronic device to apply a second helper matrix to second data in the secure space to generate second reproduced authentication data mapped to the second data.

According to an example embodiment, the instructions, when executed individually and/or collectively by the at least one processor, may cause the electronic device to test the first helper matrix and the second helper matrix, based on a first angle between the first reproduced authentication data and the reference data and a second angle between the second reproduced authentication data and the reference data.

According to an example embodiment, a method may include selecting reference data from a secure space set for authentication data.

According to an example embodiment, the method may further include applying a first helper matrix to first data in the secure space to generate first reproduced authentication data mapped to the first data.

According to an example embodiment, the method may further include applying a second helper matrix to second data in the secure space to generate second reproduced authentication data mapped to the second data.

According to an example embodiment, the method may further include testing the first helper matrix and the second helper matrix, based on a first angle between the first reproduced authentication data and the reference data and a second angle between the second reproduced authentication data and the reference data.

According to an example embodiment, a storage medium storing at least one computer-readable instruction may be provided.

According to an example embodiment, the at least one instruction, when executed by at least one processor of an electronic device, may cause the electronic device to perform at least one operation.

According to an example embodiment, the at least one operation may comprise an operation of selecting reference data from a secure space set for authentication data.

According to an example embodiment, the at least one operation may comprise an operation of applying a first helper matrix to first data in the secure space to generate first reproduced authentication data mapped to the first data.

According to an example embodiment, the at least one operation may comprise an operation of applying a second helper matrix to second data in the secure space to generate second reproduced authentication data mapped to the second data.

According to an example embodiment, the at least one operation may comprise an operation of testing the first helper matrix and the second helper matrix, based on a first angle between the first reproduced authentication data and the reference data and a second angle between the second reproduced authentication data and the reference data.

### BRIEF DESCRIPTION OF DRAWINGS

FIG. 1 is a diagram illustrating a wireless communication system according to an example embodiment.

FIG. 2 is a block diagram illustrating a structure of an electronic device according to an example embodiment.

FIG. 3 is a block diagram illustrating a detailed structure of an electronic device according to an example embodiment.

FIG. 4 is a block diagram illustrating a structure of a server according to an example embodiment.

FIG. 5 is a diagram for describing a fuzzy extractor scheme according to an example embodiment.

FIG. 6 is a diagram for describing a fuzzy extractor scheme according to an example embodiment.

FIG. 7 is a diagram for describing a fuzzy extractor scheme according to an example embodiment.

FIG. 8 is a diagram for describing an operation of a key generating module and a reproducing module according to an example embodiment.

FIG. 9 is a flowchart illustrating an operation of an electronic device according to an example embodiment.

FIG. 10 is a flowchart illustrating an operation of a server according to an example embodiment.

FIG. 11A is a diagram for describing an one-sample Kolmogorov-Smirnov test scheme according to an example embodiment.

FIG. 11B is a diagram for describing a two-sample Kolmogorov-Smirnov test scheme according to an example embodiment.

FIG. 12 is a diagram for describing an empirical distribution function in a Kolmogorov-Smirnov test scheme according to an example embodiment.

FIG. 13 is a diagram for describing a scheme of testing a helper matrix according to an example embodiment.

FIG. 14 is a diagram for describing a scheme of testing a helper matrix according to an example embodiment.

FIG. 15 is a flowchart illustrating an operating method of an electronic device according to an example embodiment.

### DETAILED DESCRIPTION

Hereinafter, an example embodiment will be described in detail with reference to the accompanying drawings. In the following description of an example embodiment, a detailed description of relevant known functions or configurations incorporated herein will be omitted when it is determined that the description may make the subject matter of an example embodiment unnecessarily unclear. The terms which will be described below are terms defined in consideration of the functions in the disclosure, and may be different according to users, intentions of the users, or customs. Therefore, the definitions of the terms should be made based on the contents throughout the specification.

It should be noted that the technical terms used herein are only used to describe a specific embodiment, and are not intended to limit an example embodiment. Alternatively, the technical terms used herein should be interpreted to have the same meaning as those commonly understood by a person skilled in the art to which the disclosure pertains, and should not be interpreted have excessively comprehensive or excessively restricted meanings unless particularly defined as other meanings. Alternatively, when the technical terms used herein are wrong technical terms that cannot correctly represent the idea of the disclosure, it should be appreciated that they are replaced by technical terms correctly understood by those skilled in the art. Alternatively, the general terms used in an example embodiment should be interpreted as defined in dictionaries or interpreted in the context of the relevant part, and should not be interpreted to have excessively restricted meanings.

Alternatively, a singular expression used herein may include a plural expression unless they are definitely different in the context. As used herein, such an expression as “comprises” or “include”, or the like should not be interpreted to necessarily include all elements or all operations described in the specification, and should be interpreted to be allowed to exclude some of them or further include additional elements or operations.

Alternatively, the terms including an ordinal number, such as expressions “a first” and “a second” may be used to describe various elements, but the corresponding elements should not be limited by such terms. These terms are used merely to distinguish between one element and any other element. For example, a first element may be termed a second element, and similarly, a second element may be termed a first element without departing from the scope of the disclosure.

It should be understood that when an element is referred to as being “connected” or “coupled” to another element, it may be connected or coupled directly to the other element, or any other element may be interposer between them. In contrast, it should be understood that when an element is referred to as being “directly connected” or “directly coupled” to another element, there are no element interposed between them.

Hereinafter, an example embodiment will be described in detail with reference to the accompanying drawings. Regardless of drawing signs, the same or like elements are provided with the same reference numeral, and a repeated description thereof will be omitted. Alternatively, in describing an example embodiment, a detailed description of relevant known technologies will be omitted when it is determined that the description may make the subject matter of the disclosure unclear. Alternatively, it should be noted that the accompanying drawings are presented merely to help easy understanding of the technical idea of the disclosure, and should not be construed to limit the technical idea of the disclosure. The technical idea of the disclosure should be construed to cover all changes, equivalents, and alternatives, in addition to the drawings.

Hereinafter, an example embodiment will describe an electronic device as an example, but the electronic device may be referred to as a terminal, a mobile station, a mobile equipment (ME), a user equipment (UE), a user terminal (UT), a subscriber station (SS), a wireless device, a handheld device, and an access terminal (AT). Alternatively, in an example embodiment, the electronic device may be a device having a communication function such as, for example, a mobile phone, a personal digital assistant (PDA), a smart phone, a wireless MODEM, and a notebook.

In describing an example embodiment in detail, we will refer to a fuzzy extractor, which is an authentication scheme which generates authentication data (e.g., a codeword or a secret key) used for user authentication by applying a fuzzy technology to biometric data, and uses separate secure data (e.g., a helper matrix or helper data) together with the generated authentication data for the user authentication, but the main point of the disclosure is that even when other authentication schemes with a similar technical background are applied, it may be applied with slight modifications within the scope not far outside the scope of the disclosure, which will be possible at the judgment of those with technical knowledge skilled in the technical field of the disclosure.

In an embodiment, examples of the biometric data (or biometric information) may include face data, voice data, fingerprint data, palmistry data, iris data, and/or blood vessel data. Such biometric data represents a unique characteristic of a user, and there is no risk of being stolen, copied, changed, or lost by others such as a password. Therefore, the biometrics based on the biometric data is variously used in a security field.

However, since the biometric data is a unique characteristic of the user and is very important information for the user, security of the biometric data has emerged as a very important issue. Therefore, an authentication scheme has been proposed that generates authentication data by applying a fuzzy technology to the biometric data and uses the generated authentication data together with separate secure data for the user authentication without using the biometric data itself as authentication data (or authentication information) used for the user authentication. In the authentication scheme based on such fuzzy technology, in order to ensure stability of the authentication data (e.g., a codeword or a secret key), there may be a need for testing secure data (e.g., a helper matrix or helper data) used for generating reproduced authentication data (e.g., a reproduced secret key or a reproduced codeword). According to an embodiment, the reproduced authentication data may include the authentication data (e.g., the codeword or the secret key) generated by applying the secure data (e.g., the helper matrix) to input data (e.g., the biometric data).

According to an embodiment, secure data used in a fuzzy extractor may not need to include information specifying a user. Accordingly, in the disclosure, a scheme of testing the secure data may be proposed. According to an embodiment, the scheme of testing the secure data may include a scheme of testing whether the secure data used for generating reproduced authentication data used in an authentication scheme does not include user-specific data specifying the user of an electronic device.

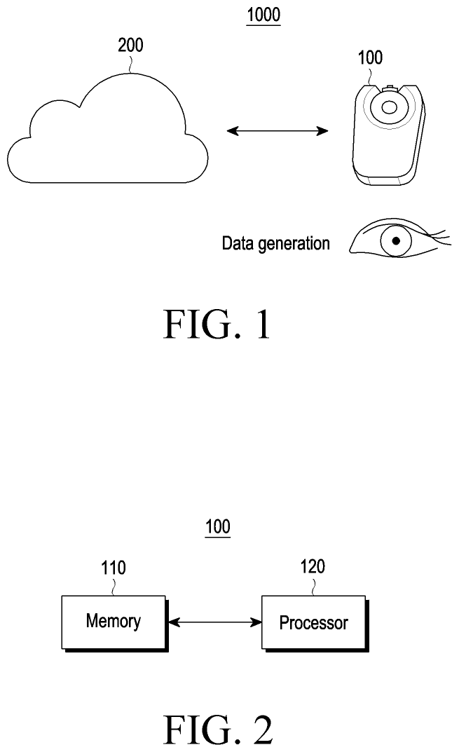

FIG. 1 is a diagram illustrating a wireless communication system according to an example embodiment.

Referring to FIG. 1, a wireless communication system 1000 may include an electronic device 100 and a server 200. The wireless communication system 1000 may be referred to as a user authentication system in terms of performing a user authentication operation based on biometric data (or biometric information) (e.g., face data, voice data, fingerprint data, palmistry data, iris data, and/or blood vessel data) of a user of the electronic device 100.

In an embodiment, the electronic device 100 generates input data (e.g., real data). In an embodiment, the real data may include biometric data such as face data, voice data, fingerprint data, palmistry data, iris data, and/or blood vessel data of the user of the electronic device 100. In an embodiment, the real data may include user information or device information in a form of real numbers, such as information related to a location of the electronic device 100 (e.g., signal strength and/or global positioning system (GPS) information). In an embodiment, the electronic device 100 may include at least one sensor capable of sensing the biometric data from a body of the user. The electronic device 100 may obtain the biometric data having a real number form based on the at least one sensor.

In an embodiment, the electronic device 100 may generate an authentication-related key based on the generated real data. In an embodiment, the authentication-related key may include at least one of a codeword, a helper matrix (or helper data), and a reproduced codeword. In an embodiment, the codeword and/or the reproduced codeword may be authentication data used for user authentication, and the helper matrix may be secure data used for the user authentication. In an embodiment, the reproduced codeword may be data based on the biometric data, and the secure data may be data used for generating the reproduced codeword.

In an embodiment, the codeword may be the authentication data used for the user authentication and may also be referred to as a “secret key.” In an embodiment, the codeword may be randomly generated. In an embodiment, the codeword may include a plurality of (e.g., 512) elements, and a set number (e.g., 16) elements of the plurality of elements may be non-zero elements, and the remaining number of elements may be zero elements. For example, each of the 16 non-zero elements may have a magnitude of ¼ (e.g., a value of ±¼), and each of the remaining elements (e.g., zero elements) may have a value of 0. As such, since each of the 16 elements has a value of ±¼, a magnitude of the generated codeword may have a value of 1.

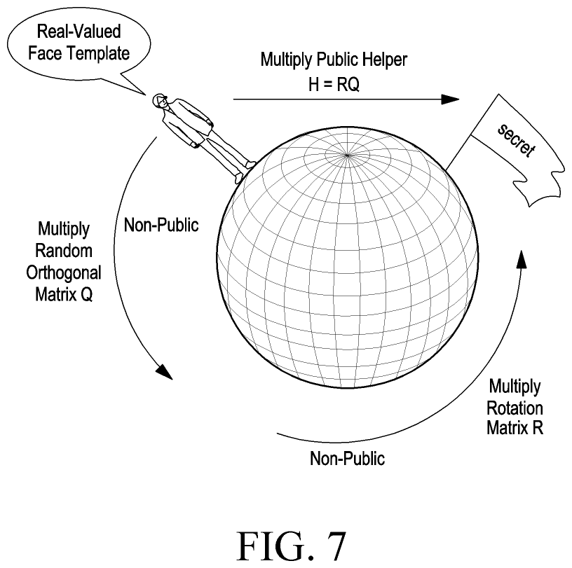

In an embodiment, the helper matrix may be a matrix used for relatively moving a value of a surface of a sphere (e.g., a hypersphere) on the surface of the sphere. The helper matrix may be used for converting the input data (e.g., the real data (e.g., the biometric data)) into the reproduced codeword (or the reproduced secret key), and may also be referred to as a “public key.” In an embodiment, the helper matrix may be configured based on one movement operation, or may be configured by a plurality of movement operations. The configuration of the helper matrix will be described below with reference to FIG. 6 or 7. According to an embodiment, the helper matrix may not need to include information specifying the user of the electronic device 100.

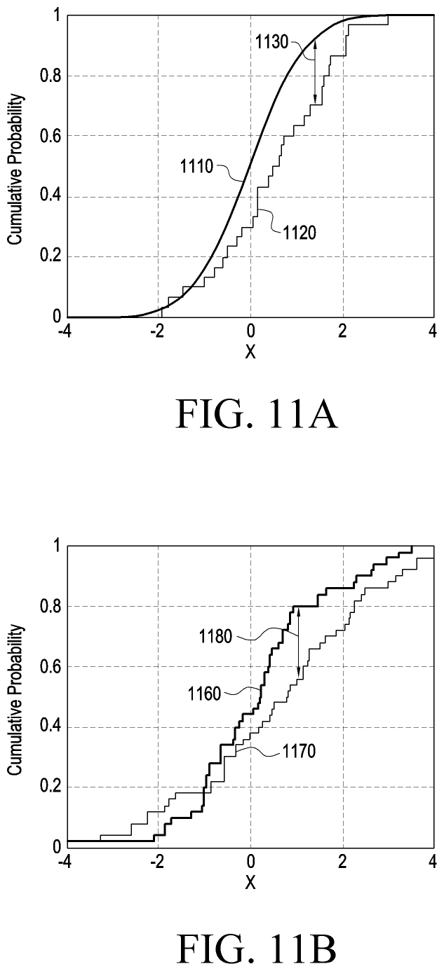

Accordingly, in the disclosure, a scheme of testing the helper matrix may be proposed in order to secure stability of the authentication data (e.g., the reproduced codeword or the reproduced secret key). According to an embodiment, the scheme of testing the helper matrix may include a scheme of testing whether the helper matrix includes the information specifying the user of the electronic device 100. According to an embodiment, the scheme of testing the helper matrix may be based on a Kolmogorov-Smirnov test scheme. The scheme of testing the helper matrix will be described with reference to FIGS. 11A to 16.

In an embodiment, the reproduced codeword (or the reproduced secret key) may be generated by applying the input data (e.g., the real data) to the helper matrix. In an embodiment, a format of the reproduced codeword may correspond to a format of the codeword.

In an embodiment, the electronic device 100 may perform an error correcting operation on the generated-reproduced codeword. The electronic device 100 may approximate an element value of each of elements constituting the reproduced codeword to a set value or a zero (0) value. For example, if only the 16 elements of the 512 elements included in the codeword are non-zero elements, the reproduced codeword generated by the helper matrix and the input data may have a magnitude of 1, and each element may have an approximate value (e.g., +0.25012, −0.0034) to ±¼ or 0.

In this case, the electronic device 100 may perform an error correcting operation by approximating a value of an element having a value approximated to 0.25 to ¼, approximating a value of an element having a value approximated to −0.25 to −¼, and approximating a value of an element having a value approximated to 0 to 0. When the error correcting operation is performed, each of the 16 elements of the 512 elements may have a value of ±¼, and each of the remaining elements may have a value of 0 in the same format as the codeword in the corresponding reproduced codeword.

In an embodiment, the electronic device 100 may be implemented as a biometric information scanner, a smartphone, a tablet PC, a mobile phone, a video phone, a camera, an infrared (IR) sensor device, a microphone device, a desktop PC, a laptop PC, a netbook computer, a workstation, a personal digital assistant (PDA), a portable multimedia player (PMP), an MP3 player, a medical device, or a wearable device, and/or the like, but is not limited thereto.

In an embodiment, the server 200 may receive the reproduced codeword (or the reproduced secret key) from the electronic device 100 and perform a user authentication operation based on the received reproduced codeword. In an embodiment, the server 200 may perform the user authentication operation on the electronic device 100 by comparing a codeword stored in memory (e.g., database) of the server 200 with the reproduced codeword received from the electronic device 100.

In an embodiment, the server 200 may store a codeword (e.g., codeword C) for a user (e.g., user A) of the electronic device 100, and if a reproduced codeword is received from the electronic device 100, the server 200 may perform a user authentication operation on the electronic device 100 by comparing the received reproduced codeword with the codeword stored by the server 200.

In an embodiment, if the error correcting operation is not performed on the reproduced codeword (or the reproduced secret key) in the electronic device 100, the server 200 may calculate an inner product sum between the codeword stored by the server 200 and the reproduced codeword received from the electronic device 100, and identify whether the codeword stored by the server 200 and the reproduced codeword received from the electronic device 100 are the same by identifying whether the calculated inner product sum is less than a threshold value.

In an embodiment, if the error correcting operation is not performed on the reproduced codeword in the electronic device 100, the server 200 may perform a user authentication operation for the electronic device 100 by identifying whether the codeword stored by the server 200 and the reproduced codeword received from the electronic device 100 are the same.

As described above, in the wireless communication system 1000 according to an embodiment, if the electronic device 100 performs the error correcting operation on the reproduced codeword based on the input data (e.g., the real data (e.g., the biometric data)), there is no need to perform a separate process of converting the real data into binary data, so more accurate error correction or user authentication may be possible. Furthermore, in the wireless communication system 1000 according to an embodiment, if the electronic device 100 performs the error correcting operation on the reproduced codeword based on the real data (e.g., the biometric data), there is no need to perform the separate process of converting the real data into the binary data, so faster error correction or user authentication may be possible.

Meanwhile, in FIG. 1, the case that the electronic device 100 generates the authentication-related key (e.g., the codeword, the helper matrix, or the reproduced codeword) and performs the test operation on the helper matrix has been described as an example, however, the server 200 may generate the authentication-related key (e.g., the codeword, the helper matrix, or the reproduced codeword) and perform the test operation on the helper matrix.

In addition, in FIG. 1, a case that a device (e.g., the electronic device 100) which obtains real data (e.g., biometric data) and generates an authentication-related key (e.g., a codeword, a helper matrix, or a reproduced codeword) and a device (e.g., the server 200) which performs a user authentication operation using the generated helper matrix are different has been described as an example, however, an operation of obtaining the real data (e.g., the biometric data), generating the authentication-related key (e.g., the codeword, the helper matrix, or the reproduced codeword), and performing the user authentication using the generated helper matrix may be performed on one device (e.g., the electronic device 100 or the server 200). For example, in electronic devices 100 such as a smart phone, an operation of directly obtaining real data (e.g., biometric data) from a user, generating a reproduced codeword based on the obtained real data (e.g., the biometric data), and performing user authentication by comparing the generated reproduced codeword with a codeword stored in advance in electronic device 100 may be performed.

In addition, in FIG. 1, the case that the electronic device 100 obtains the real data (e.g., the biometric data) and generates the reproduced codeword based on the obtained real data has been described as an example, however, a device on which an operation of obtaining the real data is performed and a device in an operation of generating the reproduced codeword based on the real data may be different. In addition, in FIG. 1, the case that the electronic device 100 and the server 200 perform the user authentication operation in conjunction with each other has been described as an example, but at least three devices may perform the user authentication operation in conjunction with one other.

FIG. 2 is a block diagram illustrating a structure of an electronic device according to an example embodiment.

Referring to FIG. 2, an electronic device 100 (e.g., an electronic device 100 in FIG. 1) may include memory 110 and a processor 120.

In an embodiment, at least one instruction related to the electronic device 100 may be stored in the memory 110. For example, various programs (or software) related to an operation of the electronic device 100 may be stored in the memory 110.

The memory 110 may store a helper matrix. The memory 110 may store a reproduced codeword generated based on the helper matrix. According to an embodiment, the memory 110 may be implemented as a memory physically separated from the processor 120. The memory 110 may be implemented in a form of memory that is inserted into the electronic device 100 depending on a purpose, or may be implemented in a form of memory that is detachable from the electronic device 100. The memory 110 may be implemented in a form of volatile memory (e.g., dynamic RAM (DRAM), static RAM (SRAM), and/or synchronous dynamic RAM (SDRAM)), non-volatile memory (e.g., one time programmable ROM (OTPROM), programmable ROM (PROM), erasable and programmable ROM (EPROM), electrically erasable and programmable ROM (EEPROM), mask ROM, flash ROM, and/or flash memory (e.g., NAND flash or NOR flash)), a hard drive, or a solid state drive (SSD), a memory card (e.g., compact flash (CF), secure digital (SD), micro secure digital (Micro-SD), mini secure digital (Mini-SD), extreme digital (xD), and/or a multi-media card (MMC)), and/or external memory connectable to a universal serial bus (USB) port (e.g., USB memory). The memory 110 may be implemented as internal memory such as read only memory (ROM) (e.g., electrically erasable programmable read only memory (EEPROM)) and/or random access memory (RAM) included in the processor 120.

According to an embodiment, the processor 120, comprising processing circuitry, may control the overall operation of the electronic device 100. For example, the processor 120 may control the overall operation of the electronic device 100 by executing the at least one instruction stored in the memory 110. According to an embodiment, the processor 120 may include at least one of a central processing unit (CPU), a micro controller unit (MCU), a micro processing unit (MPU), a controller, a system on chip (SoC), large scale integration (LSI), an application-specific integrated circuit (ASIC), a field programmable gate array (FPGA), a graphics processing unit (GPU), an application processor (AP), and/or a communication processor (CP).

According to an embodiment, the processor 120 may perform an operation of generating an authentication related key (e.g., a codeword, a helper matrix, or a reproduced codeword). According to an embodiment, the processor 120 may generate a codeword and control the generated codeword to be stored in the memory 110 or to be transmitted to a server (e.g., a server 200 in FIG. 1). Alternatively, the codeword may be generated (or selected) by the server, and the electronic device 100 may receive and use the codeword generated by the server.

According to an embodiment, the processor 120 may generate a helper matrix. For example, the processor 120 may select a random orthogonal matrix for moving input data (e.g., real data) in a random direction, calculate a rotation matrix for rotating the real data, and generate a helper matrix using the real data, the selected random orthogonal matrix, and the calculated rotation matrix. A specific operation of generating the helper matrix will be described below with reference to FIGS. 6 and 7.

According to an embodiment, if user authentication is required, the processor 120 may apply the helper matrix to inputted real data to generate a reproduced codeword. For example, when the real data is inputted, the processor 120 may multiply the real data by the helper matrix to generate the reproduced codeword including a plurality of elements.

According to an embodiment, if the electronic device 100 performs a user authentication operation by itself, the processor 120 may perform the user authentication operation by comparing the codeword and the reproduced codeword. The processor 120 may calculate an inner product sum of the codeword and the reproduced codeword, and if a magnitude of the calculated inner product sum is less than a threshold value, it may be determined that the codeword and the reproduced codeword are the same.

According to an embodiment, the processor 120 may perform an error correcting operation on the reproduced codeword and perform the user authentication operation by comparing the codeword with the reproduced codeword on which the error correcting operation is performed.

As described above, if the electronic device 100 according to an embodiment performs the error correcting operation on the reproduced codeword based on the real data (e.g., the biometric data), there is no need to perform a separate process of converting the real data into binary data, so more accurate error correction or user authentication may be possible. Furthermore, if the electronic device 100 according to an embodiment performs the error correcting operation on the reproduced codeword based on the real data (e.g., the biometric data), there is no need to perform the separate process of converting the real data into the binary data, so faster error correction or user authentication may be possible.

According to an embodiment, the processor 120 may perform an operation of testing the helper matrix. According to an embodiment, a scheme of testing the helper matrix may include a scheme of testing whether the helper matrix includes the information specifying the user of the electronic device 100. According to an embodiment, the scheme of testing the helper matrix may be based on a Kolmogorov-Smirnov test scheme. The scheme of testing the helper matrix will be described with reference to FIGS. 11A to 16.

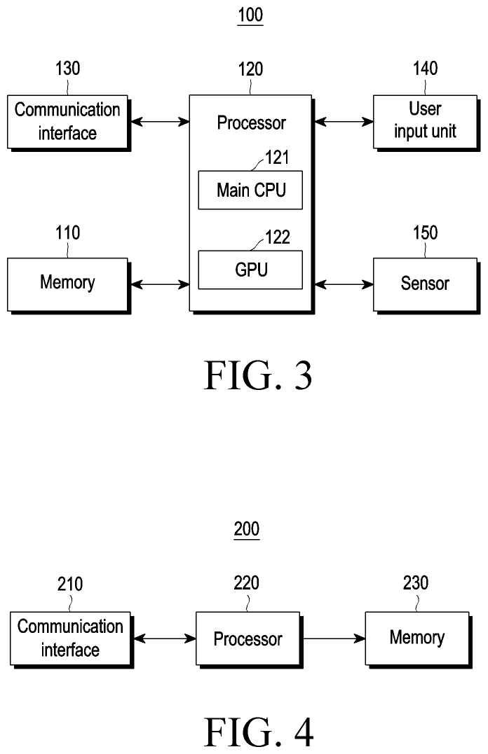

FIG. 3 is a block diagram illustrating a detailed structure of an electronic device according to an example embodiment.

Referring to FIG. 3, an electronic device 100 (e.g., an electronic device 100 in FIG. 1 or FIG. 2) may include memory 110 (e.g., memory 110 in FIG. 2), a processor 120 (e.g., a processor 120 in FIG. 2), a communication interface 130, a user input unit 140, and/or a sensor 150.

The memory 110 may be implemented to be similar to or substantially the same as to the memory 110 in FIG. 2, so a detailed description thereof is omitted herein.

According to an embodiment, the communication interface 130 may support establishing a direct (e.g., wired) communication channel or a wireless communication channel between the electronic device 100 and an external device (e.g., an external electronic device or a server (e.g., a server 200 in FIG. 1)) and performing communication via the established communication channel. The communication interface 130 may include one or more communication processors that are operable independently from the processor 120 (e.g., the application processor (AP)) and supports a direct (e.g., wired) communication or a wireless communication. According to an embodiment, the communication interface 130 may include a wireless communication interface (e.g., a cellular communication interface, a short-range wireless communication interface, or a global navigation satellite system (GNSS) communication interface) or a wired communication interface (e.g., a local area network (LAN) communication interface or a power line communication interface). A corresponding communication interface of these communication interfaces may communicate with the external device via a first network (e.g., a short-range communication network, such as Bluetooth™, wireless-fidelity (Wi-Fi) direct, or infrared data association (IrDA)) or a second network (e.g., a long-range communication network, such as a legacy cellular network, a 5^{th} generation (5G) network, a next-generation communication network, the Internet, or a computer network (e.g., LAN or wide area network (WAN)). A plurality of types of communication interfaces may be implemented as a single component (e.g., a single chip), or may be implemented as a plurality of components (e.g., a plurality of chips). The wireless communication interface may identify or authenticate the electronic device 100 in a communication network, such as the first network or the second network, using subscriber information (e.g., international mobile subscriber identity (IMSI)) stored in a subscriber identification module (SIM).

The wireless communication interface may support a 5G network, after a 4th generation (4G) network, and next-generation communication technology, e.g., new radio (NR) access technology. The NR access technology may support enhanced mobile broadband (eMBB), massive machine type communications (mMTC), or ultra-reliable and low-latency communications (URLLC). The wireless communication interface may support a high-frequency band (e.g., the mmWave band) to achieve, e.g., a high data transmission rate. The wireless communication interface may support various schemes for securing performance on a high-frequency band, such as, e.g., beamforming, a massive multiple-input and multiple-output (massive MIMO) scheme, a full dimensional MIMO (FD-MIMO) scheme, an array antenna scheme, an analog beam-forming scheme, or a large scale antenna scheme. The wireless communication interface may support various requirements specified in the electronic device 100, the external device (e.g., the external electronic device), or a network system (e.g., the second network). According to an embodiment, the wireless communication interface may support a peak data rate (e.g., 20 Gbps or more) for implementing eMBB, loss coverage (e.g., 164 dB or less) for implementing mMTC, or U-plane latency (e.g., 0.5 ms or less for each of downlink (DL) and uplink (UL), or a round trip of 1 ms or less) for implementing URLLC.

According to an embodiment, the processor 120, comprising processing circuitry, may include a main CPU 121 and a GPU 122. The main CPU 121 may access the memory 110 and perform a booting operation using an operating system (O/S) stored in the memory 110. The processor 120 may perform various operations using various programs and/or content data stored in the memory 110. The GPU 122 may correspond to a high-performance processing device for graphic processing, and may be an electronic circuit designed to quickly process data stored in the memory 110 and accelerate generation of images within a frame buffer to output a processed result via a display, or specialized in a real operation. The GPU 122 may include a visual processing unit (VPU).

According to an embodiment, the user input unit 140 may input various user commands (or user inputs) and information. The processor 120 may execute functions corresponding to the user commands inputted via the user input unit 140 or store the information inputted via the user input unit 140 in the memory 110.

According to an embodiment, the sensor 150 may generate input data (e.g., real data). The sensor 150 may be a camera which captures a face, or a microphone (not shown) which records a user voice. According to an embodiment, the processor 120 may perform various operations, such as extracting and/or editing, on the real data generated by the sensor 150 to generate real data. For example, the processor 120 may extract user face data from an image captured by the sensor 150, and extract real data required for face recognition from the extracted face data.

Meanwhile, in FIG. 3, the case that the electronic device 100 includes five components, such as the memory 110, the processor 120, the communication interface 130, the user input unit 140, and the sensor 150 has been described as an example, however, the electronic device 100 may further include other components in addition to the components described in FIG. 3, or the electronic device 100 may be implemented in a form in which some of the components described in FIG. 3 are omitted.

In addition, in FIG. 3, the case that the processor 120 includes the main CPU 121 and the GPU 122 has been described as an example, however, the processor 120 may further include an operational circuit which performs an operation of generating an authentication-related key (e.g., a codeword, a helper matrix, or a vector) and/or an operation of testing a helper matrix.

FIG. 4 is a block diagram illustrating a structure of a server, comprising processing circuitry, according to an example embodiment.

Referring to FIG. 4, a server 200 (e.g., a server 200 in FIG. 1) may include a communication interface 210 comprising interface circuitry, a processor 220 comprising processing circuitry, and/or memory 230.

According to an embodiment, the communication interface 210 may transmit and receive a signal and/or data from and to an electronic device (e.g., an electronic device 100 in FIG. 1 or FIG. 3). The communication interface 210 may receive, from the electronic device, various signals and/or data, such as input data (e.g., real data (e.g., biometric data)), a codeword, and/or a reproduced codeword. Thereafter, the communication interface 210 may transmit a user authentication result for the electronic device to the electronic device. The communication interface 210 may be implemented to be similar to or substantially the same as a communication interface 130 described in FIG. 3, so a detailed description thereof is omitted herein.

According to an embodiment, at least one instruction related to the server 200 may be stored in the memory 230. For example, various programs (or software) for operating the server 200 according to an example embodiment may be stored in the memory 230. The memory 230 may store a helper matrix. The helper matrix may be generated by the server 200, and may also be received from the electronic device via the communication interface 210. The memory 230 may store a vector (or a second codeword or a reproduced codeword) generated using the helper matrix. The memory 230 may store real data required for generating the helper matrix. The memory 230 may store various data required for an operation of testing the helper matrix.

According to an embodiment, the processor 220, comprising processing circuitry, may control each component included in the server 200. If biometric data is received from the electronic device, the processor 220 may calculate a reproduced codeword using a helper matrix stored in the memory 230. Alternatively, the server 200 may receive a calculated reproduced codeword from the electronic device via the communication interface 210. According to an embodiment, the processor 220 may perform a user authentication operation using the codeword stored in the memory 230 and the calculated reproduced codeword. For example, the processor 220 may identify that user authentication is successful if the codeword stored in the memory 230 and the calculated reproduced codeword are the same, or if an inner product of the codeword and the calculated reproduced codeword is less than a threshold value. The processor 220 may transmit a user authentication result (e.g., a result of a user authentication operation) to the electronic device via the communication interface 210.

As described above, if the server 200 according to an embodiment performs the error correcting operation on the reproduced codeword based on the real data (e.g., the biometric data), there is no need to perform a separate process of converting the real data into binary data, so more accurate error correction or user authentication may be possible. Furthermore, if the server 200 according to an embodiment performs the error correcting operation on the codeword based on the real data (e.g., the biometric data), there is no need to perform the separate process of converting the real data into the binary data, so faster error correction or user authentication may be possible.

According to an embodiment, the processor 220 may perform an operation of testing the helper matrix. According to an embodiment, a scheme of testing the helper matrix may include a scheme of testing whether the helper matrix includes the information specifying the user of the electronic device. According to an embodiment, the scheme of testing the helper matrix may be based on a Kolmogorov-Smirnov test scheme. The scheme of testing the helper matrix will be described with reference to FIGS. 11A to 16.

Meanwhile, in FIG. 4, the case that the server 200 includes three components, such as the communication interface 210, the processor 220, and the memory 230 has been described as an example, however, the server 200 may further include other components in addition to the components described in FIG. 4, or the server 200 may be implemented in a form in which some of the components described in FIG. 4 are omitted.

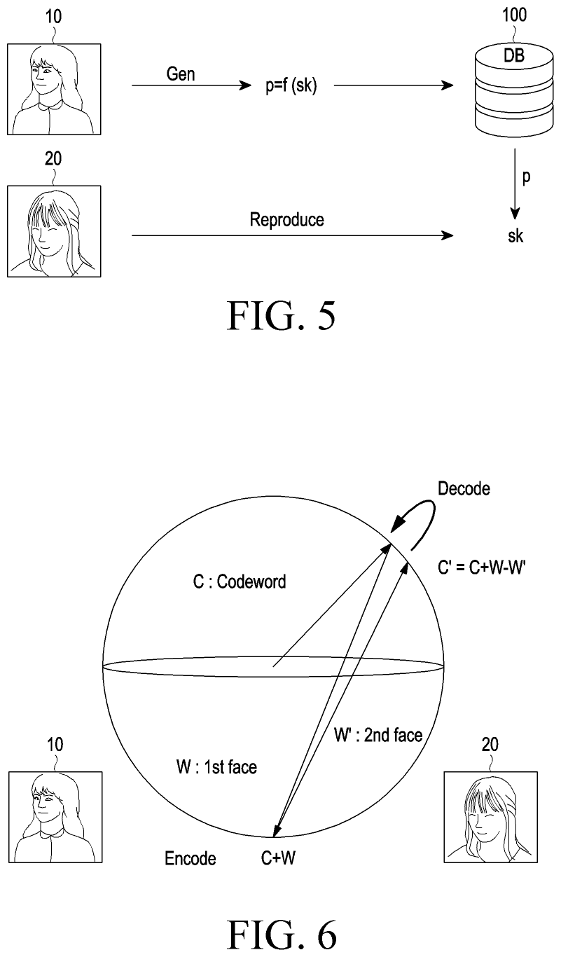

FIG. 5 is a diagram for describing a fuzzy extractor scheme according to an example embodiment.

Referring to FIG. 5, there may be various schemes for generating authentication data (e.g., a reproduced codeword or a reproduced secret key) based on input data (e.g., biometric information or biometric data), and a fuzzy extractor scheme may be an authentication scheme for extracting authentication data from the biometric data itself.

In the fuzzy extractor scheme, a helper matrix (p) may be generated based on biometric information (x), and the helper matrix (p) may be used for restoring a codeword if biometric information similar to biometric information which has been pre-registered (or which has been pre-stored) is presented later. For example, as illustrated in FIG. 5, it will be assumed that the helper matrix (p) is generated based on first real data (10) at the time of initial registration. If second real data (20) which is not identical to but similar to the first real data (10) is presented at the time when a user authentication operation is performed, a reproduced codeword (sk) may be generated based on the second real data (20) and the helper matrix (p) (this operation is illustrated as “Reproduce” in FIG. 5). In an embodiment, the helper matrix (p) may be expressed as p=f (sk), where sk may represent the reproduced codeword.

According to an embodiment, biometric data such as fingerprint data and/or iris data may have a data structure in a form of binary. For the biometric data having the data structure in the form of binary, an error correcting operation using a technology such as a Hamming distance metric may be performed. However, since an existing Hamming distance metric may be applied only to binary data, the error correcting operation using a Hamming distance metric technology may not be directly performed on biometric data having a data structure in a form of real number such as a face and/or voice. In order to overcome this limitation, the disclosure may newly propose an error correcting technology applicable to data in a form of real number (e.g., real data), and the error correcting technology applicable to the real data will be described as follows.

An error correcting operation for input data (e.g., real data) according to an embodiment may be performed on an n-dimensional sphere (e.g., a hypersphere) satisfying Equation 1 as below.

$${S}^{n} = \{ x = ( {x}_{1} , {x}_{2} , … , {x}_{n} \} \vert {x}_{1}^{2} + {x}_{2}^{2} + … + {x}_{n}^{2} = 1 \} \qquad [ Equation 1 ]$$

In Equation 1, Sⁿ may represent the n-dimensional sphere.

A distance between two vectors (e.g., two reproduced codewords or two second codewords) in the n-dimensional sphere Sⁿ may be calculated by a cosine function, and an operation on the two vectors may be performed based on spherical coordinates. The closest vector may be found based on orthogonal coordinates. In this case, a codeword may be expressed in Equation 2 as below.

$$C = {U}_{i = 1}^{1} {C}_{i} . \qquad [ Equation 3 ]$$

In Equation 2, C denotes the codeword, and Ci is Cᵢ{x₁, x₂, . . . , xₙ}∈Sⁿ|wt(x)=i and xⱼ=xₖ if xⱼ, xₖ≠0 or all j,k] For example, in a four-dimensional sphere S⁴, C₁ may be {(±1,0,0,0), (0,±1,0,0), (0,0,±1,0), (0,0,0,±1)} C₂ may be

$$\{ ( \frac{1}{\sqrt{2}} , \frac{1}{\sqrt{2}} , 0 , 0 ) , ( \frac{1}{\sqrt{2}} , 0 , \frac{1}{\sqrt{2}} , 0 ) , … , ( 0 , 0 , - \frac{1}{\sqrt{2}} , - \frac{1}{\sqrt{2}} ) \} ,$$

### and C₃ may be

$$\{ ( \frac{1}{\sqrt{3}} , \frac{1}{\sqrt{3}} , \frac{1}{\sqrt{3}} , 0 ) , ( \frac{1}{\sqrt{3}} , 0 , \frac{1}{\sqrt{3}} , \frac{1}{\sqrt{3}} ) , … , ( 0 , - \frac{1}{\sqrt{3}} , - \frac{1}{\sqrt{3}} , - \frac{1}{\sqrt{3}} ) \} .$$

For a convenience of description, it will be assumed below that the codeword is C₁₆ in S⁵¹², but is not limited thereto. According to an embodiment, there may be no limitation on a dimension of a sphere in which the codeword is generated, the number of elements included in the codeword, or the codeword selected from the sphere of the corresponding dimension.

Referring back to Equation 2, a minimum distance between two vectors in Ci may be

$$1 - \frac{1}{{2}^{i - 1}} ,$$

and a minimum distance between two vectors in Cᵢ and Cⱼ may be

$$\frac{1}{\sqrt{{2}^{j - i}}}$$

(when i<j). Accordingly, a decoding operation may be performed via a process of finding the closest codeword for each element included in Cᵢ.

FIG. 6 is a diagram for describing a fuzzy extractor scheme according to an example embodiment.

Referring to FIG. 6, first, a codeword (C) may be generated. Specifically, among a plurality of elements (e.g., 512 elements), some elements (e.g., 16 elements) have preset values (e.g., non-zero values or values of ±¼), the remaining elements have values of 0, and one of sets having a preset magnitude may be selected as the codeword (C). The generated codeword may be outputted by applying a Hash function. According to an embodiment, in a fuzzy extractor scheme, a helper matrix (p) may be generated to move inputted real data 10 (e.g., first real data (W) 10) to the codeword (C).

In such a sphere environment, if the same rotation processing is performed on the inputted real data (e.g., the first real data (W) (10)), a value (C′) for a second real data (W′) (20) may be the same as a difference value between the first real data (W) 10 and the second real data (W′) 20 is added to the codeword (C).

According to an embodiment, since only some of a plurality of elements included in the codeword have a set value, not all surfaces of a sphere are available as the codeword, so there may be positionable coordinates, and a vector for the second real data may be used as the codeword by finding adjacent corresponding coordinates.

As described above, since real data (e.g., a reproduced codeword) moved by a helper matrix is not identical to biometric data (e.g., the codeword), the helper matrix may be used as a public key. In FIG. 6, the case that the input data (e.g., the real data) is moved only once to produce the reproduced codeword has been described as an example, but the input data (e.g., the real data) may also be moved multiple times to produce the reproduced codeword.

FIG. 7 is a diagram for describing a fuzzy extractor scheme according to an example embodiment.

Referring to FIG. 7, in a fuzzy extractor scheme, a codeword may be randomly selected from a set satisfying a condition of Equation 1. In the fuzzy extractor scheme, a random orthogonal matrix satisfying Q∈R^{n×n} may be selected. Here, the random orthogonal matrix may be a matrix for moving input data (e.g., real data) in a random direction.

In the fuzzy extractor scheme, a rotation matrix for rotating the real data may be produced. According to an embodiment, if real data (z) satisfying z∈Sⁿ is inputted, first intermediate data (u=Qz) may be obtained by multiplying the real data (z) by a selected random orthogonal matrix (Q). Second intermediate data (v=c−u^{T}cu) may be obtained by performing a unit orthogonalization process (e.g., a Gram-Schmidt process) on the codeword (C) and the first intermediate data (u).

Thereafter, a rotation angle (Θ) between the codeword (C) and the first intermediate data (u) may be produced. Using the produced rotation angle (Θ), the first intermediate data (u), and the second intermediate data (v), a rotation matrix (R=I−uu^{T}−vv^{T}+[u v]R_{Θ}[u v]^{T}) may be produced. Finally, a helper matrix (H=RQ) may be generated using the produced rotation matrix and the random orthogonal matrix.

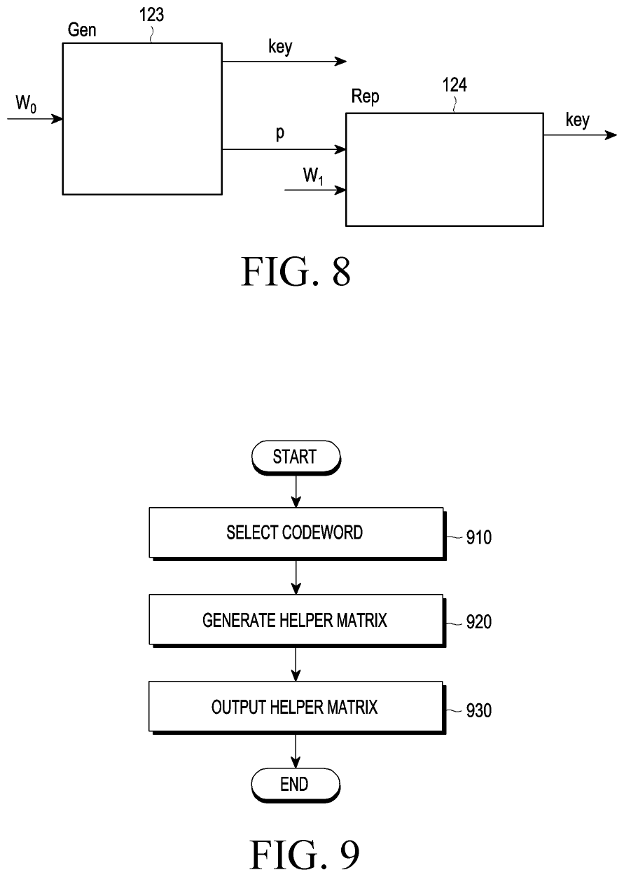

FIG. 8 is a diagram for describing an operation of a key generating module and a reproducing module according to an example embodiment.

Referring to FIG. 8, a key generating module 123 and a reproducing module 124 are disclosed. The key generating module 123 and the reproducing module 124 may be a hardware component within a processor 120 (e.g., a computational block within an ASIC) or may be a software module.

According to an embodiment, the key generating module 123 may generate an authentication-related key. In an embodiment, the authentication-related key may include at least one of a codeword, a helper matrix (or helper data), or a reproduced codeword. According to an embodiment, the key generating module 123 may select, as the codeword, one of vectors including a plurality of elements and having a set magnitude. For example, if only 16 elements of 512 elements in the codeword have a set value and the remaining elements have a value of 0, the codeword may be generated by randomly selecting the 16 elements having the set value of the 512 elements.

According to an embodiment, the key generating module 123 may generate a helper matrix (p) by reflecting real data (W₀) to the generated codeword. Such the helper matrix may be implemented in a form of moving the real data once on a spherical surface, or may be implemented in a form of moving the real data multiple times on the spherical surface. According to an embodiment, if the helper matrix is implemented in the form of moving the real data once on the spherical surface, the helper matrix may be calculated by matrix multiplying the generated codeword by the real data. According to an embodiment, if the helper matrix is implemented in the form of moving the real data twice on the spherical surface, a random orthogonal matrix for moving the real data in a random direction is selected, a rotation matrix for rotating the real data is calculated, and the helper matrix may be generated using the real data, the selected random orthogonal matrix, and the calculated rotation matrix.

According to an embodiment, the key generating module 123 may be implemented with an instruction for performing the above-described operation. In this case, the helper matrix (p) may be generated using a GPU (e.g., GPU 122 in FIG. 3). According to an embodiment, the key generating module 123 may be implemented with hardware (e.g., an ASIC) capable of performing the above-described computational operation.

According to an embodiment, the reproducing module 124 may generate a reproduced codeword when real data (W₁) is inputted. Specifically, the reproducing module 124 may calculate the reproduced codeword by multiplying the real data (W₁) by the helper matrix. The reproducing module 124 may generate the same key (or codeword) if the real data (W₁) similar to real data (W₀) used when generating the helper matrix is inputted by making each element included in the calculated reproduced codeword have a set value or a value of 0.

According to an embodiment, if real data with noise is inputted, the reproducing module 124 may decode a unique codeword within a range where an angle difference between the codeword and the inputted real data satisfies a condition of the following Equation 3.

$${cos}^{- 1} ( max \{ 1 - \frac{1}{{2}^{m - 1}} \cdot \frac{1}{\sqrt{2}} \} ) / 2 \qquad [ Equation 3 ]$$

According to an embodiment, the reproducing module 124 may be implemented as a set of instructions (e.g., a program) for performing the above-described operation. In this case, a vector may be generated using the above-described GPU. According to an embodiment, the reproducing module 124 may be implemented as hardware (e.g., an ASIC) capable of performing the above-described computational operation.

As described above, a fuzzy extractor scheme according to the disclosure does not need to convert real data into binary data, so a decrease in accuracy does not occur. In addition, the fuzzy extractor scheme according to the disclosure does not need a separate conversion process, so faster error correction or user authentication processing may be possible.

In the above, the case that the error correcting technology for the real data according to the disclosure is used in the fuzzy extractor scheme has been described as an example, but the real data is not limited to biometric information and may be various information (e.g., location information according to an antenna signal, etc.) and may be applied to various fields.

In FIG. 8, the case that the key generating module 123 and the reproducing module 124 are components included in an electronic device (e.g., an electronic device 100 in FIG. 1, FIG. 2, or FIG. 3) has been described as an example, but at least one of the key generating module 123 and the reproducing module 124 may be included in a server (e.g., a server 200 in FIG. 1 or FIG. 4).

In FIG. 8, the case that the key generating module 123 and the reproducing module 124 are included in one device (e.g., the electronic device) has been described as an example, but the electronic device may include only the key generating module 123 or only the reproducing module 124.

FIG. 9 is a flowchart illustrating an operation of an electronic device according to an example embodiment.

Referring to FIG. 9, in operation 910, an electronic device (e.g., an electronic device 100 in FIG. 1, 2, or 3) (e.g., a processor (e.g., a processor 120 in FIG. 2 or 3)) may select (e.g., generate), as a codeword, one of vectors including a plurality of elements and having a set magnitude. For example, a set number of elements among a plurality of elements included in the codeword may have the same value (e.g., a value of ±¼) which is not zero (0). The codeword may be implemented to be similar to or substantially the same as that described in FIGS. 1 to 8, so a detailed description thereof will be omitted herein.

In operation 920, the electronic device may generate a helper matrix based on the selected codeword and real data. The helper matrix may be implemented to be similar to or substantially the same as that described in FIGS. 1 to 8, so a detailed description thereof will be omitted herein.

In operation 930, the electronic device may output the helper matrix. The helper matrix may be used as a public key.

Operations 910, 920, and/or 930 described in FIG. 9 may be implemented similarly or substantially identically by a server (e.g., a server 200 in FIG. 1 or 4) (e.g., a processor (e.g., a processor 220 in FIG. 4)) as well as the electronic device (e.g., the electronic device 100 in FIG. 1, 2, or 3) (e.g., the processor (e.g., the processor 120 in FIG. 2 or 3)).

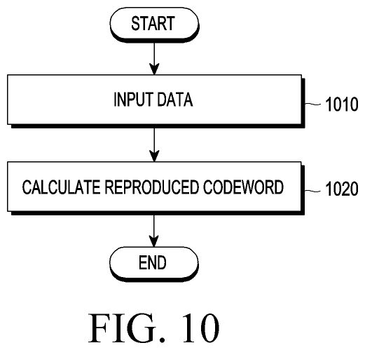

FIG. 10 is a flowchart illustrating an operation of a server according to an example embodiment.

Referring to FIG. 10, in operation 1010, a server (e.g., a server 200 in FIG. 1 or 4) (e.g., a processor (e.g., a processor 220 in FIG. 4)) may input real data.

In operation 1020, the server may calculate a reproduced codeword including a plurality of elements by reflecting the inputted real data into a helper matrix which relatively moves a value of a sphere surface on the sphere surface.

Meanwhile, after calculating the reproduced codeword, the server may identify the identity between the calculated reproduced codeword and a codeword corresponding to the helper matrix. According to an embodiment, the server may calculate an inner product sum of the calculated reproduced codeword and the codeword corresponding to the helper matrix, and identify the identity between the calculated reproduced codeword and the codeword corresponding to the helper matrix by whether a magnitude of the calculated inner product sum is less than a threshold value. According to an embodiment, after calculating the replay reproduced codeword, the server may perform an error correcting operation on the calculated reproduced codeword. According to an embodiment, an element value of each of a plurality of elements included in the reproduced codeword may be approximated to a set value or a value of 0.

Operations 1010 and/or 1020 described in FIG. 10 may be implemented similarly or substantially identically by an electronic device (e.g., an electronic device 100 in FIG. 1, 2, or 3) (e.g., a processor 120 in FIG. 2 or 3)) as well as the server (e.g., the server 200 in FIG. 1 or 4) (e.g., the processor (e.g., the processor 220 in FIG. 4)).

As described above, secure data (e.g., a helper matrix or helper data) may be a very important factor in a fuzzy extractor scheme, so there may be a need for testing secure data (or secure information) used for generating authentication data (or authentication information) in order to secure stability of the authentication data used for authentication (e.g., user authentication), According to an embodiment, the authentication data may include a secret key (or a codeword), and the secure data may include the helper matrix (or helper data). According to an embodiment, a scheme of testing the helper matrix may include a scheme of testing whether the helper matrix includes information which specifies a user of an electronic device (e.g., an electronic device 100 in FIG. 1, 2, or 3). According to an embodiment, the scheme of testing the helper matrix may be based on Kolmogorov-Smirnov test scheme.

According to an example embodiment, an electronic device (an electronic device 100 in FIG. 1, 2, or 3, or a server 200 in FIG. 1 or 4) may comprise at least one processor (a processor 120 in FIG. 2 or 3, or a processor 220 in FIG. 4), and memory (memory 110 in FIG. 2 or 3, or memory 230 in FIG. 4) storing instructions. In an embodiment, the processor may be circuitry such as a CPU, an MPU, an AP, a CP, a System On Chip (SoC), an Integrated Circuit (IC), etc. In an embodiment, the processor may be hardware, software, or anything which may perform operations and functions claimed in the claims.

According to an example embodiment, the instructions, when executed by the processor, may cause the electronic device to select reference data from a secure space set for authentication data.

According to an example embodiment, the instructions, when executed by the processor, may cause the electronic device to apply a first helper matrix to first data in the secure space to generate first reproduced authentication data mapped to the first data.

According to an example embodiment, the instructions, when executed by the processor, may cause the electronic device to apply a second helper matrix to second data in the secure space to generate second reproduced authentication data mapped to the second data.

According to an example embodiment, the instructions, when executed by the processor, may cause the electronic device to test the first helper matrix and the second helper matrix, based on a first angle between the first reproduced authentication data and the reference data and a second angle between the second reproduced authentication data and the reference data.

According to an example embodiment, the instructions, when executed by the processor, may cause the electronic device to test the first helper matrix and the second helper matrix, based on a first empirical distribution function for the first angle and a second empirical distribution function for the second angle.

According to an example embodiment, the instructions, when executed by the processor, may cause the electronic device to identify that it is impossible to extract the first data based on the first helper matrix and it is impossible to extract the second data based on the second helper matrix if a difference between a function value of a first empirical distribution function for the first angle and a function value of a second empirical distribution function for the second angle is less than a threshold value.

According to an example embodiment, the secure space may include an n-dimensional hypersphere.

According to an example embodiment, the instructions, when executed by the processor, may cause the electronic device to test the first helper matrix and the second helper matrix, based on a Kolmogorov-Smirnov test scheme.

According to an example embodiment, the instructions, when executed by the processor, may cause the electronic device to accept a null hypothesis if a difference between a function value of a first empirical distribution function for the first angle and a function value of a second empirical distribution function for the second angle is less than a threshold value.

According to an example embodiment, the instructions, when executed by the processor, may cause the electronic device to select at least one piece of additional reference data from the secure space.

According to an example embodiment, the instructions, when executed by the processor, may cause the electronic device to test the first helper matrix and the second helper matrix, based on a third angle between the first reproduced authentication data and the at least one piece of additional reference data and a fourth angle between the second reproduced authentication data and the at least one piece of additional reference data.

According to an example embodiment, the instructions, when executed by the processor, may cause the electronic device to test the first helper matrix and the second helper matrix, based on a third empirical distribution function for the third angle and a fourth empirical distribution function for the fourth angle.

According to an example embodiment, the instructions, when executed by the processor, may cause the electronic device to identify that it is impossible to extract the first data based on the first helper matrix and it is impossible to extract the second data based on the second helper matrix if a difference between a function value of a third empirical distribution function for the third angle and a function value of a fourth empirical distribution function for the fourth angle is less than a threshold value.

According to an example embodiment, the at least one piece of additional reference data may be selected based on a number of elements included in at least one of the first helper matrix or the second helper matrix.

FIG. 11A is a diagram for describing an one-sample Kolmogorov-Smirnov test scheme according to an example embodiment.

Referring to FIG. 11A, a Kolmogorov-Smirnov test scheme may include a nonparametric test scheme for continuous (or discontinuous) equality. An one-sample Kolmogorov-Smirnov test scheme may include a scheme used for comparing a sample probability distribution with a reference probability distribution.

In FIG. 11A, reference number 1110 may represent a theory distribution function, reference number 1120 may represent a distribution function for a sample, and reference number 1130 may represent an one-sample Kolmogorov-Smirnov statics.

Kolmogorov-Smirnov statistics may be obtained by quantizing a distance between an empirical distribution function for a sample and a cumulative distribution function for reference distribution, or between empirical distribution functions of two samples. Null distribution of this statistics may be extracted under a null hypothesis that a sample is extracted from the reference distribution (in a case of the one-sample Kolmogorov-Smirnov test scheme) or that samples are extracted from the same distribution (in a case of a two-sample Kolmogorov-Smirnov test scheme).

In the one-sample Kolmogorov-Smirnov test scheme, the distribution considered under the null hypothesis may be continuous, discrete, or mixed. An empirical distribution function for n independent and identically distributed (i.i.d.) ordered observations Xᵢ may be expressed as Equation 4 below.

$$[ Equation 4 ]$$

$${F}_{n} ( x ) = \frac{number of ( elements in the sample \leq x )}{n} = \frac{1}{n} {\sum }_{i = 1}^{n} {1}_{( - ∞ , x )} ( {X}_{i} )$$

In Equation 4, 1_{(-∞,x]}(Xᵢ) may represent an indicator function. If Xᵢ≤x, 1_{(-∞,x]}(Xᵢ) may be 1, and if not, 1_{(-∞,x]}(Xᵢ) may be 0.

Kolmogorov-Smirnov statistics for a given cumulative distribution function F(x) may be expressed as Equation 5 below.

$${D}_{n} = {sup}_{x} \vert {F}_{n} ( x ) - F ( x ) \vert \qquad [ Equation 5 ]$$

In Equation 5, supₓ may represent supremum of a set of distances, and the statistics may have the largest absolute difference between two distribution functions over all x values. According to Glivenko-Cantelli theorem, if a sample is derived from the cumulative distribution function F(x), then Dₙ may almost certainly converge to 0 (zero) as it goes to infinity.

FIG. 11B is a diagram for describing a two-sample Kolmogorov-Smirnov test scheme according to an example embodiment.

Referring to FIG. 11B, a two-sample Kolmogorov-Smirnov test scheme may be a scheme used for comparing probability distributions for two samples. In FIG. 11B, reference number 1160 may represent a distribution function for a first sample, reference number 1170 may represent a distribution function for a second sample, and reference number 1180 may represent two-sample Kolmogorov-Smirnov statistics.

The two-sample Kolmogorov-Smirnov test scheme may be used for testing whether two one-dimensional probability distributions are different. In this case, the Kolmogorov-Smirnov statistics may be expressed as in Equation 6 below.

$${D}_{n , m} = {sup}_{x} \vert {F}_{1 , n} ( x ) - {F}_{2 , m} ( x ) \vert . \qquad [ Equation 6 ]$$

In Equation 6, F_{1,n}(x) may represent an empirical distribution function for the first sample, and F_{2,m}(x) may represent an empirical distribution function for the second sample.

For large samples, a null hypothesis may be rejected at level α if a condition in Equation 7 below is satisfied.

$${D}_{n , m} > c ( α ) \sqrt{\frac{n + m}{n \cdot m}} \qquad [ Equation 7 ]$$

In Equation 7, n may be a magnitude of the first sample, and m may be a magnitude of the second sample. A value of c(α) may be given as shown in Table 1 below for the most common level of level α.

TABLE 1

| α | 0.20 | 0.15 | 0.10 | 0.05 | 0.025 | 0.01 | 0.005 | 0.001 |
|---|---|---|---|---|---|---|---|---|
| c(α) | 1.073 | 1.138 | 1.224 | 1.358 | 1.48 | 1.628 | 1.731 | 1.949 |

In general,

$$c ( α ) > \sqrt{- ln ( \frac{α}{2} ) \cdot \frac{1}{2}} ,$$

so a condition may read

$${D}_{n , m} > \sqrt{- ln ( \frac{α}{2} ) \cdot \frac{1 + \frac{m}{n}}{2 m}} .$$

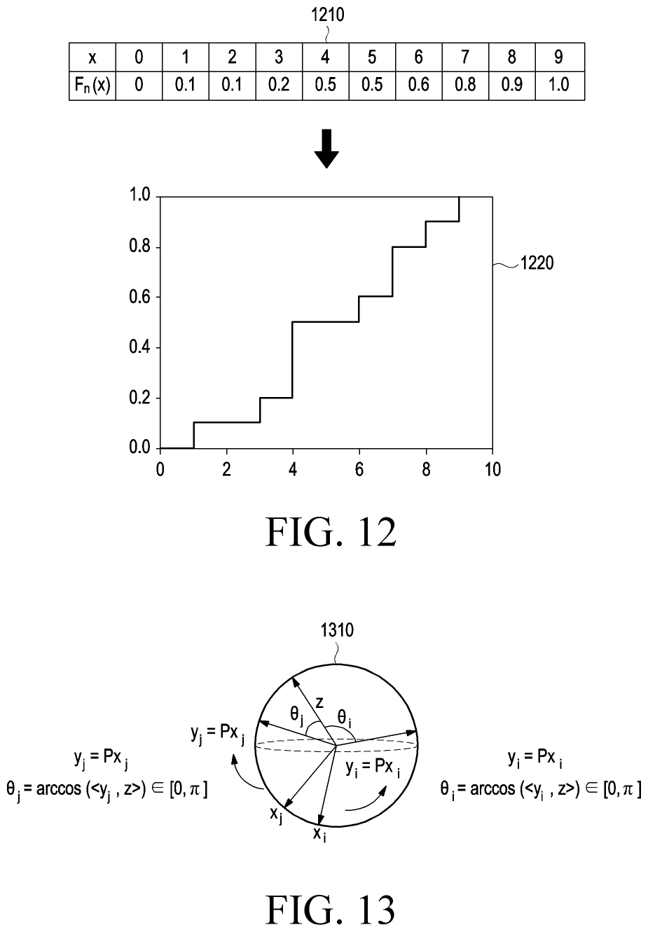

FIG. 12 is a diagram for describing an empirical distribution function in a Kolmogorov-Smirnov test scheme according to an example embodiment.

Referring to FIG. 12, if there are n pieces of data x₁, x₂, . . . , xₙ, an empirical distribution function Fₙ(x) may be expressed as in Equation 8 below.

$${F}_{n} ( x ) = \frac{1}{n} {\sum }_{j = 1}^{n} {1}_{{x}_{j} \leq x} , {1}_{{x}_{j} \leq x} = \{ \begin{matrix}1 & if {x}_{j} \leq x \\ 0 & if {x}_{j} > x\end{matrix} \qquad [ Equation 8 ]$$

Therefore, the empirical distribution function Fₙ(x) as in Equation 8 may be expressed as in Equation 9 below.

$${F}_{n} ( x ) = \frac{\{ the number of {x}_{j} which is less than or equal to x \}}{n} . \qquad [ Equation 9 ]$$

A range of values of the empirical distribution function Fₙ(x) may include [0,1], similar to a range of values of a general probability distribution function. For example, if values of given samples are 4, 7, 6, 1, 8, 4, 7, 4, 3, 9, a value of the empirical distribution function Fₙ(x) may be expressed as shown in Table 2 below (the value of the the empirical distribution function Fₙ(x) is marked with reference number 1210 in FIG. 12).

TABLE 2

| x | 0 | 1 | 2 | 3 | 4 | 5 | 6 | 7 | 8 | 9 |
|---|---|---|---|---|---|---|---|---|---|---|
| Fₙ (x) | 0 | 0.1 | 0.1 | 0.2 | 0.5 | 0.5 | 0.6 | 0.8 | 0.9 | 1.0 |

An empirical distribution function based on a value of the empirical distribution function Fₙ(x) for each data is marked with reference number 1220 in FIG. 12.

According to an embodiment, in a two-sample Kolmogorov-Smirnov test scheme, Kolmogorov-Smirnov statistics may include supremum of a difference between empirical distribution functions for two samples. If an empirical distribution function for the first sample is Fₘ(x) and an empirical distribution function for the second sample is Gₙ(x), the Kolmogorov-Smirnov statistics D_{m,n} may be expressed as Equation 10 below.

$${D}_{m , n} = {sup}_{x} \vert ( {F}_{m} - {G}_{n} ) ( x ) \vert \qquad [ Equation 10 ]$$

A null hypothesis H₀ may indicate that two samples have the same distribution, and alternative hypothesis H₁ may indicate that the two samples do not have the same distribution.

Critical value D_{α} according to a level α and a sample size may be expressed as shown in Table 3 below.

TABLE 3

| | |
|---|---|
| Number of | Level of significance, α |

| [symbol] | 0.10 | 0.05 | 0.02 | 0.01 |
|---|---|---|---|---|
| 1 | 0.95000 | 0.97500 | 0.99000 | 0.99500 |
| 2 | [symbol] | [symbol] | 0.90000 | 0.92929 |
| 3 | [symbol] | [symbol] | 0.78456 | [symbol] |
| 4 | [symbol] | [symbol] | [symbol] | [symbol] |
| 5 | [symbol] | [symbol] | [symbol] | [symbol] |

[symbol]

indicates data missing or illegible when filed

If a condition expressed in Equation 11 is satisfied, the null hypothesis may be rejected.

$$\sqrt{\frac{mn}{m + n}} {D}_{m , n} > {D}_{α} \qquad [ Equation 11 ]$$

FIG. 13 is a diagram for describing a scheme of testing a helper matrix according to an example embodiment.

Referring to FIG. 13, a helper matrix may be a very important factor in a fuzzy extractor scheme, so there may be a need for testing secure data (or secure information) used for generating authentication data (or authentication information) in order to secure stability of the authentication data used for authentication (e.g., user authentication), According to an embodiment, the authentication data may include a secret key (or a codeword), and the secure data may include the helper matrix (or helper data).

According to an embodiment, a scheme of testing the helper matrix may include a scheme of testing whether the helper matrix includes information which specifies a user of an electronic device (e.g., an electronic device 100 in FIG. 1, 2, or 3). According to an embodiment, the scheme of testing the helper matrix may be based on Kolmogorov-Smirnov test scheme. Hereinafter, for a convenience of description, the scheme of testing the helper matrix will be referred to as a “helper matrix test scheme.”

According to an embodiment, two samples corresponding to two helper matrices generated from two different face templates may not be distinguished. Therefore, in the helper matrix test scheme, the helper matrix may be tested based on a two-sample Kolmogorov-Smirnov test scheme. The two-sample Kolmogorov-Smirnov test scheme may be applied only to samples expressed as a real value (e.g., a scalar value). However, since the helper matrix is a real matrix, not a real value, it may be difficult to directly apply the two-sample Kolmogorov-Smirnov test scheme to the helper matrix.

Therefore, the disclosure may propose a helper matrix test scheme which tests a helper matrix using an angle generated based on the helper matrix instead of the helper matrix. In an embodiment, the angle may be a real value between 0 and π. In an embodiment, an angle Θᵢ between a value yᵢ, which is moved by applying a helper matrix P to a point xᵢ on a surface of a sphere (e.g., a hypersphere) 1310, and a reference value z may be calculated. In an embodiment, the hypersphere may include a space (e.g., a secure space) where biometric data and/or a codeword (or a secret key) exist. In an embodiment, the hypersphere may include the secure space, and the secure space may include a space set for authentication data or input data (or real data (e.g., biometric data)). According to an embodiment, the secure space may include an n-dimensional hypersphere. According to an embodiment, the authentication data may include the secret key (or the codeword). The codeword and the secret key may be implemented to be similar to or substantially the same as those described in FIGS. 1 to 12, so a detailed description thereof will be omitted.

In an embodiment, the case that the angle Θᵢ between the value yᵢ, which is moved by applying the helper matrix P to the point xᵢ, which is a ransom value, on the hypersphere, and a reference value z is calculated has been described as an example, however, the biometric data may be inputted to the point xᵢ. In an embodiment, the point xᵢ may be input data (e.g., random input data) for generating a scalar value to be used in the helper matrix test scheme, and a reference value z may be a z vector. In an embodiment, the reference value (or reference data) may be randomly selected from the secure space (e.g., the hypersphere).

In the helper matrix test scheme, the point xᵢ and the reference value z are randomly selected on the hypersphere surface, scalar values are derived from the helper matrix P, and the helper matrix P may be tested based on the derived scalar values and the two-sample Kolmogorov-Smirnov test scheme.

According to an embodiment, the helper matrix P may include a matrix which moves the input data on the secure space to maps the input data to reproduced authentication data (e.g., a reproduced codeword). According to an embodiment, the helper matrix P may include a function which maps the input data (e.g., the biometric data) to the reproduced authentication data (e.g., the reproduced codeword) if the input data is inputted. For example, if biometric data of the user of the electronic device is inputted as the input data, the helper matrix P may be applied to the biometric data to generate a reproduced codeword corresponding to the biometric data of the user of the electronic device. If the generated reproduced codeword is identical to a codeword of the electronic device, the inputted biometric data may be identified as the biometric data of the user of the electronic device, so user authentication for the user of the electronic device may be successful.

In a wireless communication system, if an attacker exists, the attacker may attempt an attack using the helper matrix P. In this case, the attacker may attempt a statistical attack by applying input data, for example, various random values random(x), to the helper matrix P and checking the corresponding random values are mapped to which reproduced codewords. However, a helper matrix generated based on the helper matrix test scheme according to an embodiment may not include information specifying the user of the electronic device (e.g., the electronic device 100 in FIGS. 1 to 3), even through the statistical attack by the attacker. Accordingly, even if a helper matrix which does not include the information specifying the user of the electronic device is used for the attack by the attacker, the attacker may not obtain the information specifying the user of the electronic device, so stability of the authentication data may be secured.

In FIG. 13, P may represent a helper matrix (or a public key) of the electronic device. According to an embodiment, the helper matrix P may be a matrix having a size of n×n, where n may vary depending on a vector dimension of face data.

In FIG. 13, xⱼ may represent an n-dimensional random sample vector value used for mapping a matrix to a vector value. In FIG. 13, xⱼ may represent first input data (or a first sample).

In FIG. 13, yⱼ may represent an n-dimensional vector value as a value obtained by multiplying xⱼ by the helper matrix P. In FIG. 13, yⱼ may represent first reproduced authentication data generated by applying the helper matrix P to the first input data.

In FIG. 13, z may represent a reference random vector value used for mapping a vector to a scalar value. In FIG. 13, z may represent a reference value randomly selected from a secure space (e.g., an n-dimensional hypersphere).

In FIG. 13, Θⱼ may be an angle formed by z and yⱼ, and may represent a scalar value derived from the helper matrix P. In FIG. 13, θⱼ may represent a first angle between the first reproduced authentication data and the reference value.

In FIG. 13, xᵢ may represent an n-dimensional random sample vector value used for mapping a matrix to a vector value. In FIG. 13, xᵢ may represent second input data (or a second sample).

In FIG. 13, yᵢ may represent an n-dimensional vector value as a value obtained by multiplying xᵢ by the helper matrix P. In FIG. 13, yᵢ may represent second reproduced authentication data generated by applying the helper matrix P to the second input data.

In FIG. 13, Θᵢ may be an angle formed by z and yᵢ, and may represent a scalar value derived from the helper matrix P. In FIG. 13, Θᵢ may represent a second angle between the second reproduced authentication data and the reference value.

According to an embodiment, a dataset for a fuzzy extractor scheme may be expressed as Equation 12 below.

$$X = \{ {x}_{i} \vert {x}_{i} ← {U}_{1} \} , Z = \{ {z}_{j} \vert {z}_{j} ← {U}_{1} \} \qquad [ Equation 12 ]$$

$${E}_{A} = \{ {y}_{i} \vert {y}_{i} = {P}_{A} \cdot {x}_{i} , where {x}_{i} ∈ X \}$$

$${E}_{A , {x}_{j}} = \{ {θ}_{i , j} \vert {θ}_{i , j} = arc cos ( \{ {y}_{i} , {z}_{j} \} ) , where {y}_{i} ∈ {E}_{A} , {z}_{j} ∈ Z \}$$

As shown in Equation 12, if the dataset for the fuzzy extractor scheme exists, n pieces of data may θ_{1,j}, θ_{2,j}, . . . , θ_{n,j}∈E_{x,zj} exist.

An empirical distribution function for the n pieces of data θ_{1,j}, θ_{2,j}, . . . , θ_{n,j}∈E_{x,zj} may be expressed as in Equation 13 below.

$${F}_{A}^{j} ( θ ) = \frac{1}{n} {\sum }_{i = 1}^{n} {1}_{{θ}_{i , j} \leq θ} , {1}_{{θ}_{i , j} \leq θ} = \{ \begin{matrix}1 & if {θ}_{i , j} \leq θ \\ 0 & if {θ}_{i , j} > θ\end{matrix} \qquad [ Equation 13 ]$$

According to an embodiment, if there are users (e.g., user A and user B) of two electronic devices, an empirical distribution function for a first sample corresponding to user A is F_{A}(x) and an empirical distribution function for a second sample corresponding to user B is F_{B}(x), Kolmogorov-Smirnov statistics D_{A,B} may be expressed as in Equation 14 below.

$${D}_{A , B} = {sup}_{{z}_{j} ∈ Z} \vert {sup}_{θ} \vert {F}_{A}^{j} ( θ ) - {F}_{B}^{j} ( θ ) \vert \vert \qquad [ Equation 14 ]$$

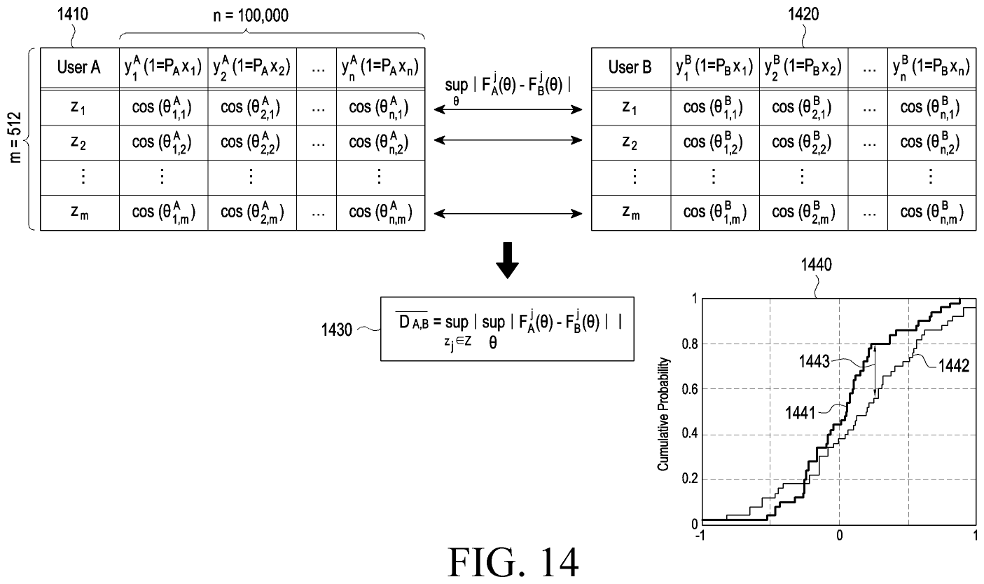

FIG. 14 is a diagram for describing a scheme of testing a helper matrix according to an example embodiment.

Referring to FIG. 14, if there are users (e.g., user A and user B) of two electronic devices, an empirical distribution function for a first sample corresponding to user A is F_{A}(x) and an empirical distribution function for a second sample corresponding to user B is F_{B}(x), Kolmogorov-Smirnov statistics D_{A,B} may be expressed as in Equation 15 below.

$$\overline{{D}_{A , B}} = {sup}_{{z}_{j} ∈ Z} \vert {sup}_{θ} \vert {F}_{A}^{j} ( θ ) - {F}_{B}^{j} ( θ ) \vert \vert \qquad [ Equation 15 ]$$

In Equation 15, second sup may be used for comparing user A and user B in one row, and first sup may be used for detecting the largest value among a total of m values.

In an embodiment, a reason for comparing user A and user B is that if a helper matrix of user A and a helper matrix of user B exist, and an empirical distribution function value of user A and an empirical distribution function value of user B are almost similar (for example, if a difference between the empirical distribution function value of user A and the empirical distribution function value of user B is less than a threshold value), each of the helper matrix of user A and the helper matrix of user B may be considered not to include user information of the corresponding user. For example, the helper matrix of user A may be considered not to include user information of user A, and the helper matrix of user B may be considered not to include user information of user B. As such, since a helper matrix does not include user information about a user of a corresponding electronic device, security of authentication data may be guaranteed even though the helper matrix is stored as a public key in a device other than the electronic device, for example, a server. In this way, if the helper matrix does not include the user information for the corresponding user, even if an attack by an attacker occurs, the attacker may not obtain the user information which specifies the corresponding user from the helper matrix, so user authentication by the attacker may be impossible.

In FIG. 14, reference numeral 1410 may represent a relationship between a reference value and a vector value of user A, and m (e.g., 512) may represent the number of reference values. According to an embodiment, a reason why the number of reference values is set to m (for example, a reason why m reference values are used) is to express all elements included in a helper matrix P. According to an embodiment, in order to express the all elements included in the helper matrix P, it may be required that at least n reference values are used. For example, n may be an integer greater than or equal to 1, and may be smaller than m.

In FIG. 14, reference number 1420 may represent a relationship between a reference value and a vector value of user B, and m may represent the number of reference values.

In FIG. 14, reference number 1430 may represent a Kolmogorov-Smirnov statistics D_{A,B} in a case that an empirical distribution function for a first sample corresponding to the user A is F_{A}(x) and an empirical distribution function for a second sample corresponding to the user B is F_{B}(x), and may be as expressed in Equation 15.

In FIG. 14, reference numeral 1440 may represent a relationship between a function value of an empirical distribution function F_{A}(x) for the first sample corresponding to the user A and a function value of an empirical distribution function F_{B}(x) for the second sample corresponding to the user B, and if a difference 1443 between the function value 1441 of the empirical distribution function F_{A}(x) for the first sample corresponding to the user A and the function value 1442 of the empirical distribution function F_{B}(x) for the second sample corresponding to the user B is less than a threshold value, a test result for a helper matrix PA corresponding to the user A and a helper matrix PB corresponding to the user B may be successful. According to an embodiment, if the difference 1443 between the function value 1441 of the empirical distribution function F_{A}(x) for the first sample corresponding to the user A and the function value 1442 of the empirical distribution function F_{B}(x) for the second sample corresponding to the user B is less than the threshold value, a null hypothesis may be accepted. According to an embodiment, if the difference 1443 between the function value 1441 of the empirical distribution function F_{A}(x) for the first sample corresponding to the user A and the function value 1442 of the empirical distribution function F_{B}(x) for the second sample corresponding to the user B is less than the threshold value, each of a helper matrix of the user A and a helper matrix of the user B may be considered not to include user information of the corresponding user. For example, the helper matrix of user A may be considered not to include user information of user A, and the helper matrix of user B may be considered not to include user information of user B. As such, since a helper matrix does not include user information about a user of a corresponding electronic device, security of authentication data may be guaranteed even though the helper matrix is stored as a public key in a device other than the electronic device, for example, a server. In this way, if the helper matrix does not include the user information for the corresponding user, even if an attack by an attacker occurs, the attacker may not obtain the user information which specifies the corresponding user from the helper matrix, so user authentication by the attacker may be impossible.

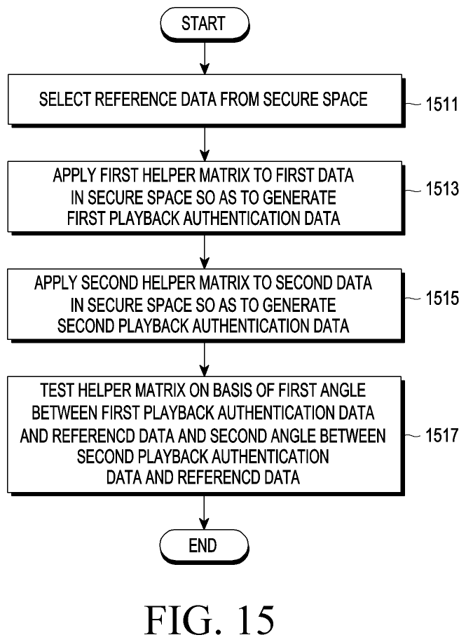

FIG. 15 is a flowchart illustrating an operating method of an electronic device according to an example embodiment.

Prior to describing FIG. 15, an operating method described in FIG. 15 may be performed not only by an electronic device (e.g., an electronic device 100 in FIGS. 1 to 3) (e.g., a processor 120 in FIG. 2 or 3) but also by a server (e.g., a server 200 in FIG. 1 or 4) (e.g., a processor 220 in FIG. 4). As described in FIGS. 1 to 14, an operation of generating a helper matrix or testing a helper matrix may be equally performed by the server as well as the electronic device. Therefore, although FIG. 15 describes the operation of testing the helper matrix using the electronic device as an example, it should be noted that the server may also perform the operation of testing the helper matrix in the same manner as the electronic device.

Referring to FIG. 15, in operation 1511, the electronic device may select reference data from a secure space set for authentication data. According to an embodiment, the authentication data may include a secret key (or a codeword). The codeword and the secret key may be implemented to be similar to or substantially the same as those described in FIGS. 1 to 14, so a detailed description thereof will be omitted. According to an embodiment, the secure space may include a space set for authentication data or input data (or real data (e.g., biometric data)). According to an embodiment, the secure space may include an n-dimensional hypersphere. According to an embodiment, the reference data may be randomly selected from the secure space. According to an embodiment, the reference data may be selected based on the number of elements included in a helper matrix (e.g., at least one of a first helper matrix or a second helper matrix).

In operation 1513, the electronic device may apply the first helper matrix to first data in the secure space to generate first reproduced authentication data. The helper matrix may include a matrix which maps input data to reproduced authentication data (e.g., a reproduced codeword) by moving the input data in the secure space. In an embodiment, the first data may include input data corresponding to a first user. In an embodiment, the first helper matrix may include a helper matrix which corresponds to the first user.

In operation 1515, the electronic device may apply the second helper matrix to the second data in the secure space to generate second reproduced authentication data. In an embodiment, the second data may include input data corresponding to a second user. In an embodiment, the second helper matrix may include a helper matrix which corresponds to the second user.

In operation 1515, the electronic device may test the first helper matrix and the second helper matrix, based on a first angle between the first reproduced authentication data and the reference data and a second angle between the second reproduced authentication data and the reference data. According to an example embodiment, the electronic device may test the first helper matrix and the second helper matrix, based on a first empirical distribution function for the first angle and a second empirical distribution function for the second angle. According to an example embodiment, the electronic device may identify that it is impossible to extract the first data based on the first helper matrix and it is impossible to extract the second data based on the second helper matrix if a difference between a function value of a first empirical distribution function for the first angle and a function value of a second empirical distribution function for the second angle is less than a threshold value. According to an example embodiment, the electronic device may test the first helper matrix and the second helper matrix, based on a Kolmogorov-Smirnov test scheme. According to an example embodiment, the electronic device may accept a null hypothesis if the difference between the function value of the first empirical distribution function for the first angle and the function value of the second empirical distribution function for the second angle is less than the threshold value.

As described in FIG. 15, in a helper matrix test scheme, since a test operation for helper matrices (e.g., the first helper matrix and the second helper matrix) for different users (e.g., a first user and a second user) is used, it may be preferable that the helper matrix test scheme is performed by the server (e.g., the server 200 in FIG. 1 or 4) (e.g., the processor 220 in FIG. 4) rather than the electronic device (e.g., the electronic device 100 in FIG. 1 to FIG. 3) (e.g., the processor 120 in FIG. 2 or 3).

According to an example embodiment, a method may include selecting reference data from a secure space set for authentication data.

According to an example embodiment, the method may further include applying a first helper matrix to first data in the secure space to generate first reproduced authentication data mapped to the first data.

According to an example embodiment, the method may further include applying a second helper matrix to second data in the secure space to generate second reproduced authentication data mapped to the second data.

According to an example embodiment, the method may further include testing the first helper matrix and the second helper matrix, based on a first angle between the first reproduced authentication data and the reference data and a second angle between the second reproduced authentication data and the reference data.

According to an example embodiment, testing the first helper matrix and the second helper matrix based on the first angle and the second angle may comprise testing the first helper matrix and the second helper matrix, based on a first empirical distribution function for the first angle and a second empirical distribution function for the second angle.

According to an example embodiment, the first helper matrix and the second helper matrix based on the first angle and the second angle may comprise identifying that it is impossible to extract the first data based on the first helper matrix and it is impossible to extract the second data based on the second helper matrix if a difference between a function value of a first empirical distribution function for the first angle and a function value of a second empirical distribution function for the second angle is less than a threshold value.

According to an example embodiment, the secure space may include an n-dimensional hypersphere.

According to an example embodiment, the first helper matrix and the second helper matrix based on the first angle and the second angle may comprise testing the first helper matrix and the second helper matrix, based on a Kolmogorov-Smirnov test scheme.

According to an example embodiment, the first helper matrix and the second helper matrix based on the first angle and the second angle may comprise accepting a null hypothesis if a difference between a function value of a first empirical distribution function for the first angle and a function value of a second empirical distribution function for the second angle is less than a threshold value.

According to an example embodiment, the method may further include selecting at least one piece of additional reference data from the secure space.

According to an example embodiment, the method may further include testing the first helper matrix and the second helper matrix, based on a third angle between the first reproduced authentication data and the at least one piece of additional reference data and a fourth angle between the second reproduced authentication data and the at least one piece of additional reference data.

According to an example embodiment, the first helper matrix and the second helper matrix based on the third angle and the fourth angle may comprise testing the first helper matrix and the second helper matrix, based on a third empirical distribution function for the third angle and a fourth empirical distribution function for the fourth angle.

According to an example embodiment, the first helper matrix and the second helper matrix based on the third angle and the fourth angle may comprise identifying that it is impossible to extract the first data based on the first helper matrix and it is impossible to extract the second data based on the second helper matrix if a difference between a function value of a third empirical distribution function for the third angle and a function value of a fourth empirical distribution function for the fourth angle is less than a threshold value.

According to an example embodiment, the at least one piece of additional reference data may be selected based on a number of elements included in at least one of the first helper matrix or the second helper matrix. “Based on” as used herein covers based at least on.

According to an example embodiment, a storage medium storing at least one computer-readable instruction may be provided.

According to an example embodiment, the at least one instruction, when executed by at least one processor (120; 220) of an electronic device (100; 200), may cause the electronic device (100; 200) to perform at least one operation.

According to an example embodiment, the at least one operation may comprise an operation of selecting reference data from a secure space set for authentication data.

According to an example embodiment, the at least one operation may comprise an operation of applying a first helper matrix to first data in the secure space to generate first reproduced authentication data mapped to the first data.

According to an example embodiment, the at least one operation may comprise an operation of applying a second helper matrix to second data in the secure space to generate second reproduced authentication data mapped to the second data.

According to an example embodiment, the at least one operation may comprise an operation of testing the first helper matrix and the second helper matrix, based on a first angle between the first reproduced authentication data and the reference data and a second angle between the second reproduced authentication data and the reference data.

It should be appreciated that various embodiments of the disclosure and the terms used therein are not intended to limit the technological features set forth herein to a specific embodiment and include various changes, equivalents, or replacements for a corresponding embodiment. With regard to the description of the drawings, similar reference numerals may be used to refer to similar or related elements. It is to be understood that a singular form of a noun corresponding to an item may include one or more of the things, unless the relevant context clearly indicates otherwise. As used herein, each of such phrases as “A or B,” “at least one of A and B,” “at least one of A or B,” “A, B, or C,” “at least one of A, B, and C,” and “at least one of A, B, or C,” may include any one of, or all possible combinations of the items enumerated together in a corresponding one of the phrases. As used herein, such terms as “1^{st}” and “2^{nd},” or “first” and “second” may be used to simply distinguish a corresponding component from another, and does not limit the components in other aspect (e.g., importance or order). It is to be understood that if an element (e.g., a first element) is referred to, with or without the term “operatively” or “communicatively”, as “coupled with,” “coupled to,” “connected with,” or “connected to” another element (e.g., a second element), it means that the element may be coupled with the other element directly (e.g., wiredly), wirelessly, or via at least a third element. Thus, for example, “connected” as used herein covers direct and indirect connections.

As used in connection with various embodiments of the disclosure, the term “module” may include a unit implemented in hardware, software, or firmware, and may interchangeably be used with other terms, for example, “logic,” “logic block,” “part,” or “circuitry”. A module may be a single integral component, or a minimum unit or part thereof, adapted to perform one or two or more functions. For example, according to an embodiment, the module may be implemented in a form of an application-specific integrated circuit (ASIC). Thus, each “module” herein may comprise circuitry.

Various embodiments as set forth herein may be implemented as software (e.g., a program) including one or more instructions that are stored in a storage medium (e.g., internal memory or external memory) that is readable by a machine. For example, a processor of the machine may invoke at least one of the one or more instructions stored in the storage medium, and execute it. This allows the machine to be operated to perform at least one function according to the at least one instruction invoked. The one or more instructions may include a code generated by a compiler or a code executable by an interpreter. The machine-readable storage medium may be provided in the form of a non-transitory storage medium. Wherein, the term “non-transitory” simply means that the storage medium is a tangible device, and does not include a signal (e.g., an electromagnetic wave), but this term does not differentiate between where data is semi-permanently stored in the storage medium and where the data is temporarily stored in the storage medium.

According to an embodiment, a method according to various embodiments of the disclosure may be included and provided in a computer program product. The computer program product may be traded as a product between a seller and a buyer. The computer program product may be distributed in the form of a machine-readable storage medium (e.g., compact disc read only memory (CD-ROM)), or be distributed (e.g., downloaded or uploaded) online via an application store (e.g., PlayStore™), or between two user devices (e.g., smart phones) directly. If distributed online, at least part of the computer program product may be temporarily generated or at least temporarily stored in the machine-readable storage medium, such as memory of the manufacturer's server, a server of the application store, or a relay server.

According to various embodiments, each component (e.g., a module or a program) of the above-described components may include a single entity or multiple entities, and some of the multiple entities may be separately disposed in different components. According to various embodiments, one or more of the above-described components or operations may be omitted, or one or more other components or operations may be added. Alternatively or additionally, a plurality of components (e.g., modules or programs) may be integrated into a single component. In such a case, the integrated component may still perform one or more functions of each of the plurality of components in the same or similar manner as they are performed by a corresponding one of the plurality of components before the integration. According to various embodiments, operations performed by the module, the program, or another component may be carried out sequentially, in parallel, repeatedly, or heuristically, or one or more of the operations may be executed in a different order or omitted, or one or more other operations may be added.

1. An electronic device, comprising:
at least one processor comprising processing circuitry; and
memory storing instructions that, when executed individually and/or collectively by the at least one processor, cause the electronic device to:
select reference data from a secure space set for authentication data,
apply a first helper matrix to first data in the secure space to generate first reproduced authentication data mapped to the first data,
apply a second helper matrix to second data in the secure space to generate second reproduced authentication data mapped to the second data, and
based on a first angle between the first reproduced authentication data and the reference data and a second angle between the second reproduced authentication data and the reference data, test the first helper matrix and the second helper matrix.

2. The electronic device of claim 1, wherein the instructions, when executed individually and/or collectively by the at least one processor, cause the electronic device to:
based on a first empirical distribution function for the first angle and a second empirical distribution function for the second angle, test the first helper matrix and the second helper matrix.

3. The electronic device of claim 1, wherein the instructions, when executed individually and/or collectively by the at least one processor, cause the electronic device to:
identify that it is impossible to extract the first data based on the first helper matrix and it is impossible to extract the second data based on the second helper matrix when a difference between a function value of a first empirical distribution function for the first angle and a function value of a second empirical distribution function for the second angle is less than a threshold value.

4. The electronic device of claim 1, wherein the secure space includes an n-dimensional hypersphere.

5. The electronic device of claim 1, wherein the instructions, when executed individually and/or collectively by the at least one processor, cause the electronic device to:
based on a Kolmogorov-Smirnov test scheme, test the first helper matrix and the second helper matrix.

6. The electronic device of claim 1, wherein the instructions, when executed individually and/or collectively by the at least one processor, cause the electronic device to:
accept a null hypothesis when a difference between a function value of a first empirical distribution function for the first angle and a function value of a second empirical distribution function for the second angle is less than a threshold value.

7. The electronic device of claim 1, wherein the instructions, when executed individually and/or collectively by the at least one processor, cause the electronic device to:
select at least one piece of additional reference data from the secure space, and
based on a third angle between the first reproduced authentication data and the at least one piece of additional reference data and a fourth angle between the second reproduced authentication data and the at least one piece of additional reference data, test the first helper matrix and the second helper matrix.

8. The electronic device of claim 7, wherein the instructions, when executed individually and/or collectively by the at least one processor, cause the electronic device to:
based on a third empirical distribution function for the third angle and a fourth empirical distribution function for the fourth angle, test the first helper matrix and the second helper matrix.

9. The electronic device of claim 7, wherein the instructions, when executed individually and/or collectively by the at least one processor, cause the electronic device to:
identify that it is impossible to extract the first data based on the first helper matrix and it is impossible to extract the second data based on the second helper matrix if a difference between a function value of a third empirical distribution function for the third angle and a function value of a fourth empirical distribution function for the fourth angle is less than a threshold value.

10. The electronic device of claim 7, wherein the at least one piece of additional reference data is selected based on a number of elements included in at least one of the first helper matrix or the second helper matrix.

11. A method performed by an electronic device, the method comprising:
selecting reference data from a secure space set for authentication data;
applying a first helper matrix to first data in the secure space to generate first reproduced authentication data mapped to the first data;
applying a second helper matrix to second data in the secure space to generate second reproduced authentication data mapped to the second data; and
based on a first angle between the first reproduced authentication data and the reference data and a second angle between the second reproduced authentication data and the reference data, testing the first helper matrix and the second helper matrix.

12. The method of claim 11, wherein the first helper matrix and the second helper matrix based on the first angle and the second angle comprises:
based on a first empirical distribution function for the first angle and a second empirical distribution function for the second angle, testing the first helper matrix and the second helper matrix.

13. The method of claim 11, wherein testing the first helper matrix and the second helper matrix based on the first angle and the second angle comprises:
identifying that it is impossible to extract the first data based on the first helper matrix and it is impossible to extract the second data based on the second helper matrix when a difference between a function value of a first empirical distribution function for the first angle and a function value of a second empirical distribution function for the second angle is less than a threshold value.

14. The method of claim 11, wherein the secure space includes an n-dimensional hypersphere.

15. A storage medium storing at least one computer-readable instruction, wherein the at least one instruction, when executed individually and/or collectively by at least one processor of an electronic device, causes the electronic device to perform operations comprising:
selecting reference data from a secure space set for authentication data;
applying a first helper matrix to first data in the secure space to generate first reproduced authentication data mapped to the first data;
applying a second helper matrix to second data in the secure space to generate second reproduced authentication data mapped to the second data; and
testing the first helper matrix and the second helper matrix, based on a first angle between the first reproduced authentication data and the reference data and a second angle between the second reproduced authentication data and the reference data.

16. The method of claim 11, wherein testing the first helper matrix and the second helper matrix based on the first angle and the second angle comprises:
based on a Kolmogorov-Smirnov test scheme, testing the first helper matrix and the second helper matrix.

17. The method of claim 11, wherein testing the first helper matrix and the second helper matrix based on the first angle and the second angle comprises:
accepting a null hypothesis when a difference between a function value of a first empirical distribution function for the first angle and a function value of a second empirical distribution function for the second angle is less than a threshold value.

18. The method of claim 11, comprising:
selecting at least one piece of additional reference data from the secure space; and
based on a third angle between the first reproduced authentication data and the at least one piece of additional reference data and a fourth angle between the second reproduced authentication data and the at least one piece of additional reference data, testing the first helper matrix and the second helper matrix.

19. The method of claim 18, wherein testing the first helper matrix and the second helper matrix based on the third angle and the fourth angle comprises:
based on a third empirical distribution function for the third angle and a fourth empirical distribution function for the fourth angle, testing the first helper matrix and the second helper matrix.

20. The method of claim 18, wherein testing the first helper matrix and the second helper matrix based on the third angle and the fourth angle comprises:
identifying that it is impossible to extract the first data based on the first helper matrix and it is impossible to extract the second data based on the second helper matrix if a difference between a function value of a third empirical distribution function for the third angle and a function value of a fourth empirical distribution function for the fourth angle is less than a threshold value.
